(19) United States
(12) Patent Application Publication
(10) Pub. No.: US 2025/0369572 A1
(43) Pub. Date: Dec. 4, 2025

(54) INSTALLATION FOR STORING AND DISPENSING CRYOGENIC FLUID

(71) Applicant: L'Air Liquide, Societe Anonyme pour l'Etude et l’Exploitation des Procedes Georges Claude, Paris (FR)

(72) Inventors: Stephane DUVAL, Paris (FR); Golo ZICK, Paris (FR)

(21) Appl. No.: 19/226,486

(22) Filed: Jun. 3, 2025

(30) Foreign Application Priority Data
Jun. 4, 2024 (FR) FRFR2405851

(51) Int. Cl. F17C 9/00

(52) U.S. Cl. CPC F17C 9/00; F17C 2205/0326; F17C 2205/0338; F17C 2205/0352; F17C 2221/012; F17C 2223/0161; F17C 2227/0302; F17C 2250/043; F17C 2250/0439; F17C 2250/0631

(57) ABSTRACT

The invention relates to an installation for storing and dispensing cryogenic fluid, for example liquid hydrogen, comprising a cryogenic tank provided with a withdrawal line configured to make it possible to withdraw liquid from the tank, and a device for pressurizing the tank comprising an injection line connected to the tank and configured to make it possible to inject fluid into the tank in order to pressurize the tank, for example in order to maintain the pressure in the tank during the withdrawal of liquid, the pressurization device comprising an ejector positioned on the injection line, the ejector having a first inlet for driving gas connected to a pressurized gas source of the installation, and a second intake inlet connected to another source of fluid, preferably liquefied, the outlet of the ejector being connected to the tank.

### CROSS REFERENCE TO RELATED APPLICATIONS

This application claims the benefit of priority under 35 U.S.C. § 119(a) and (b) to French patent application No. FR2405851, filed Jun. 4, 2024, which is herein incorporated by reference in its entirety.

### FIELD OF THE INVENTION

The invention relates to an installation for storing and dispensing cryogenic fluid. The installation advantageously applies to storing and dispensing liquid hydrogen.

### BACKGROUND OF THE INVENTION

Cryogenic liquid stores are not generally provided with withdrawal pumps, but instead use a device for pressurizing the store (for example an atmospheric exchanger positioned below the tank), allowing self-pressurization.

This device makes it possible to compensate for the loss of liquid volume in the tank during withdrawal by means of reinjection of cold hydrogen that is withdrawn and vaporized. This vaporization gas can be collected from the liquid part and vaporized before being reinjected into the gaseous phase of the store.

These pressurization devices have limited vaporization capabilities however, allowing limited nominal liquid withdrawal flow rates.

One solution would be to use an “external” atmospheric exchanger, making it possible to adjust the size thereof to the vaporization requirement in order to meet a high withdrawal flow rate. This solution encounters the problems of ensuring a very low pressure drop on the entire external circuit given the size of the exchanger and the need for a connecting hose on the return circuit. The pressure drop generated will thus without doubt be significantly greater than the hydrostatic pressure available in the store as the only driving force.

### SUMMARY OF THE INVENTION

The invention relates more particularly to an installation for storing and dispensing cryogenic fluid, for example liquid hydrogen, comprising a cryogenic tank provided with a withdrawal line configured to make it possible to withdraw liquid from the tank, and a device for pressurizing the tank comprising an injection line connected to the tank and configured to make it possible to inject fluid into the tank in order to pressurize the tank, for example in order to maintain the pressure in the tank during the withdrawal of liquid.

The invention particularly relates to withdrawing cryogenic liquid (for example liquid hydrogen) from a cryogenic tank (fixed or mobile). In some applications, the liquid withdrawal flow rate is between one and two tonnes per hour (or more may be required).

One aim of the present invention is to overcome all or some of the aforementioned drawbacks of the prior art.

In an effort to overcome the deficiencies of the prior art discussed, supra, the installation according to the invention, which otherwise corresponds to the general definition given in the preamble above, is configured such that the pressurization device comprises an ejector positioned on the injection line, the ejector having a first inlet for driving gas connected to a pressurized gas source of the installation and a second intake inlet connected to another source of fluid, preferably liquefied, the outlet of the ejector being connected to the tank.

In addition, embodiments of the invention can comprise one or more of the following features:
the second intake inlet of the ejector is connected to the withdrawal line (3),
the installation comprises a valve, for example an isolation valve and/or a valve for regulating the fluid pressure and/or flow rate admitted into the second intake inlet of the ejector,
the pressurized gas source comprises at least one pressurized gas store preferably provided with a pressure and/or flow rate regulator,
the installation comprises a sensor for measuring the pressure of the stream at the outlet of the ejector and/or in the tank,
the pressure regulator is configured to regulate the pressure and/or the flow rate of the driving gas as a function of the measurement from the pressure sensor,
the installation comprises a sensor for measuring the temperature of the stream positioned at the outlet of the ejector,
the injection line comprises a pressure and/or flow rate regulating valve positioned in parallel with the ejector,
the valve situated in parallel with the ejector is configured to regulate the temperature of the fluid downstream of the ejector as a function of the measurement from the temperature sensor,
the valve for regulating the fluid pressure and/or flow rate admitted into the second intake inlet of the ejector is configured to regulate the pressure and/or the flow rate as a function of the measurement from the temperature sensor,
the installation comprises a heat exchanger for superheating the fluid stream admitted at the second intake inlet of the ejector,
the pressurization device further comprises an additional member for pressurizing the tank comprising for example an atmospheric exchanger positioned below the tank, configured to interact, for example simultaneously, with the ejector in order to make it possible to increase the flow rate of the fluid withdrawn from the tank.

The invention can also relate to any alternative device or method comprising any combination of the features above or below within the scope of the claims.

Further distinctive features and advantages will become apparent on reading the description below, provided with reference to the figures, in which:

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

FIG. 1 is a schematic and partial vertical cross-sectional view illustrating an example of the structure and operation of an installation according the invention.

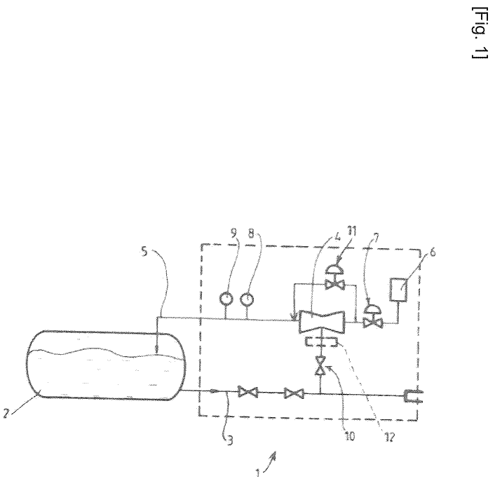

### DETAILED DESCRIPTION OF THE INVENTION

Throughout the FIGURES, the same reference signs relate to the same elements.

In this detailed description, the following embodiments are examples. Although the description refers to one or more embodiments, this does not mean that the features apply only to a single embodiment. Individual features of different embodiments can also be combined and/or interchanged to provide other embodiments.

The installation 1 for storing and dispensing cryogenic fluid illustrated comprises a cryogenic tank 2 (for example double-walled). This tank 2 is provided with a withdrawal line 3 configured to make it possible to withdraw liquid from the tank 2.

The withdrawal line 3 is not provided with a pump.

The installation 1 further comprises a device for pressurizing the tank 2 comprising an injection line 5 connected to the tank 2 (preferably emerging in the upper part of the tank 2) and configured to make it possible to inject fluid into the tank 2 in order to pressurize the tank 2.

For example, this injection line 5 makes it possible to maintain a given pressure in the tank 2, in particular during the withdrawal of liquid.

This pressurization device comprises an ejector 4 positioned on the injection line 5, having a first inlet for driving gas connected to a pressurized gas source 6 of the installation 1, and a second intake inlet connected to the withdrawal line 3, while the outlet of the ejector 4 is connected to the tank 2 by the injection line 5.

The ejector 4 makes it possible to take in liquid collected from the source tank 2 by the withdrawal line 3 using the driving force generated by the stream of pressurized driving gas supplied by the pressurized gas source 6. This produces, at the discharge (outlet) of the ejector 4, a cold gas (for example at a temperature between the saturation temperature and a superheat of 0 K to 50 K above this equilibrium in the case of hydrogen).

This structure makes it possible to generate a stream of fluid in the pressurization line 5 the flow rate and temperature of which are controlled in order to pressurize the tank 2. It particularly makes it possible to maintain the pressure in the tank 2 even for relatively high flow rates (for example greater than one tonne per hour). This pressurization device makes it possible to supply a pressurizing gas fluid flow rate that greatly exceeds the capabilities of the known pressurization systems.

In addition, this pressurization device enables relatively lower gas consumption (driving gas) compared to simply injecting a (relatively hot) gas flow into the tank from a gas source. In addition, injecting a relatively cold gas makes it possible to reduce the effect of re-condensation in the tank 2 and thus better stabilize the pressure.

The second inlet of the ejector collects a small fraction of the liquid withdrawn. As illustrated, this can be carried out by means of a bypass line provided with a valve 10 for regulating the pressure and/or the flow rate.

This liquid is taken into the ejector 4 by the Venturi effect, with the driving force generated by the flow of driving gas supplied by the source 6. The source 6 comprises for example one or more pressurized gas cylinders preferably provided with an expansion member such as a valve 7 configured to ensure a given flow rate or pressure.

The ejector 4 can be designed to obtain at its discharge outlet a mixture of liquid and gas at a given pressure in order to compensate for example for the pressure drops of the circuit between the ejector outlet 4 and the tank inlet 2.

The flow rate supplied by the ejector 4 in the gaseous volume of the tank 2 can be designed to compensate for the loss of the liquid withdrawn at a given withdrawal pressure.

The mixture of liquid and gas (typically hydrogen) makes it possible to produce a sufficient flow rate to regulate the pressure in the tank 2 while limiting the quantity of relatively hot gas supplied by the pressurized gas source 6.

The mixture of liquid and gas (typically hydrogen) makes it possible to produce a sufficient flow rate to regulate the pressure in the tank 2 while limiting the quantity of relatively hot gas supplied by the pressurized gas source 6. Each molecule used for pressurization and collected from the withdrawal flow rate 3 can be saved in the hot gas source 6. The pressure available in the hot gas source 6 is often considerably greater than the pressure necessary in the tank 2 in order to limit the transport volume. This excess pressure cannot therefore be used directly in the tank 2, and can even have a negative effect in the event of direct expansion in the tank 2, as hydrogen or helium heats up on expansion in a valve. By injecting a hot gas, the heat exchange between the cold parts of the tank 2 and the gas injected leads to the densification or even the liquefaction of this gas, which partially compensates for the pressurization effect. This detrimental compensation effect is more marked if the temperature difference is large. For pressure control, it is therefore preferable to inject a pressurizing gas that is not excessively superheated compared to equilibrium. In addition to saving molecules, mixing with some of the withdrawn liquid therefore allows thermalization at a temperature level more suitable for pressure regulation.

The consumption of collected liquid is relatively low compared to the flow of withdrawn liquid transferred to the user (for example of the order of a few percent).

The driving gas flow rate supplied at the first inlet of the ejector 4 can be regulated by a regulating valve 7 that can be governed by the discharge pressure measured at the outlet of the ejector 4 by a pressure sensor 9. This sensor 9 can also be situated directly at or on the tank 2.

Alternatively or in combination, a temperature sensor 8 can be provided at the outlet of the ejector 4 in order to make it possible to control the temperature of the stream supplied to the reservoir 2 by controlling the regulating valve 10 situated upstream of the second inlet of the ejector 4 and/or by controlling a flow rate regulating valve 11 positioned on the injection line 5, preferably in parallel with the ejector 4.

As illustrated schematically in dashed lines, the installation 1 can comprise a heat exchanger 12 for superheating the fluid (liquid) stream admitted at the second intake inlet of the ejector 4. This optional heat exchanger 12 can be an atmospheric exchanger situated at the intake of the ejector and can ensure vaporization of the liquid for improved operation, depending for example of the design of the ejector 4.

In addition, the installation 1 can comprise a flow meter at the outlet of the ejector 4 on the injection line 5. This flow meter (not shown) makes it possible to accurately determine the discharge flow rate of the ejector (in view of its design for example).

The ejector device 4 and the circuitry and all or some of the associated members can be housed inside a casing or bundle shown in dashed lines. This assembly can be incorporated into an independent mobile support separate from the tank, or a semi-trailer, or can be housed directly on the tank or store or semi-trailer.

The pressurization device can further comprise an additional member for pressurizing the tank (PBU) comprising for example an atmospheric exchanger that can be positioned below the tank and configured to interact, for example simultaneously, with the ejector 4 in order to make it possible to increase the flow rate of the fluid withdrawn from the tank 2. This additional member for pressurizing the tank (PBU) can comprise a loop that makes it possible to withdraw liquid, vaporize it in the external exchanger, and return it to the tank 2. It can be used at the same time as or sequentially with the system having an ejector 4.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. An installation for storing and dispensing cryogenic fluid, comprising:
a cryogenic tank provided with a withdrawal line configured to withdraw liquid from the cryogenic tank, and
a pressurization device configured to pressurize the tank, the pressurization device comprising an injection line connected to the cryogenic tank and configured to inject fluid into the cryogenic tank in order to pressurize the cryogenic tank,
wherein the pressurization device further comprises an ejector positioned on the injection line, the ejector having a first inlet configured to drive gas connected to a pressurized gas source of the installation, and a second intake inlet connected to another source of fluid, wherein the ejector further comprises an outlet that is connected to the cryogenic tank.

2. The installation as claimed in claim 1, wherein the second intake inlet of the ejector is connected to the withdrawal line.

3. The installation as claimed in claim 2, further comprising a regulation valve configured to regulate a fluid pressure and/or flow rate admitted into the second intake inlet of the ejector.

4. The installation as claimed in claim 1, wherein the pressurized gas source comprises at least one pressurized gas store preferably provided with a pressure and/or flow rate regulator.

5. The installation as claimed in claim 4, further comprising a sensor for measuring the pressure of the stream at the outlet of the ejector and/or in the cryogenic tank.

6. The installation as claimed in claim 5, wherein the pressure regulator is configured to regulate the pressure and/or the flow rate of the driving gas as a function of the measurement from the pressure sensor.

7. The installation as claimed in claim 1, further comprising a temperature sensor configured to measure a temperature of the stream positioned at the outlet of the ejector.

8. The installation as claimed in claim 1, wherein the injection line comprises a pressure and/or flow rate regulating valve positioned in parallel with the ejector.

9. The installation as claimed in claim 8, wherein the valve situated in parallel with the ejector is configured to regulate a temperature of the fluid downstream of the ejector as a function of a measurement from a temperature sensor configured to measure a temperature of the stream positioned at the outlet of the ejector.

10. The installation as claimed in claim 7, further comprising a regulation valve configured to regulate a fluid pressure and/or flow rate admitted into the second intake inlet of the ejector, wherein the regulation valve is configured to regulate the pressure and/or the flow rate as a function of the measurement from the temperature sensor.

11. The installation as claimed in claim 1, further comprising a heat exchanger for superheating the stream of fluid admitted at the second intake inlet of the ejector.

12. The installation as claimed in claim 1, wherein the pressurization device further comprises an additional member for pressurizing the cryogenic tank comprising an atmospheric exchanger positioned below the cryogenic tank, configured to interact simultaneously with the ejector in order to increase the flow rate of the fluid withdrawn from the cryogenic tank.

13. The installation as claimed in claim 1, wherein the cryogenic fluid is liquid hydrogen.
